(19) United States
(12) Patent Application Publication
(10) Pub. No.: US 2015/0327137 A1
(43) Pub. Date: Nov. 12, 2015

(54) INTER-NETWORK COMMUNICATION TO AVOID PING-PONGING INTER-RAT IDLE RESELECTION

(71) Applicants: Wentao Zhang, Beijing (CN); George Cherian, San Diego, CA (US); Jun Wang, Poway, CA (US)

(72) Inventors: Wentao Zhang, Beijing (CN); George Cherian, San Diego, CA (US); Jun Wang, Poway, CA (US)

(73) Assignee: QUALCOMM Incorporated, San Diego, CA (US)

(21) Appl. No.: 14/409,997

(22) PCT Filed: Aug. 14, 2012
(86) PCT No.: PCT/CN2012/080094

§ 371 Date: Dec. 19, 2014

(51) Int. Cl. H04W 36/14; H04W 24/02; H04W 12/08; H04W 72/04

(52) U.S. Cl. CPC H04W 36/14; H04W 72/0426; H04W 24/02; H04W 12/08; H04W 88/06

(57) ABSTRACT

A method, an apparatus, and a computer program product for wireless communication are provided which enable dissimilar radio access networks to exchange loading information that may be used to determine reselection criteria for mobile terminals and/or classes of mobile terminals. A network entity in one network, aware of loading conditions in another network, can determine whether a wireless terminal should attempt to reselect the other network. The method comprises receiving information related to the operational status of a first network at a second network, and determining at the second network whether to direct an idle user equipment in the second network to reselect the first network based on the operational status of the first network. The first and second networks may employ different radio access technologies.

### BACKGROUND

1. Field

The present disclosure relates generally to communication systems, and more particularly, to a systems and methods for facilitating handover and reselection between networks using different radio access technologies.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided that enable dissimilar radio access networks (RANs) to exchange loading information that may be used to determine reselection criteria for mobile terminals and/or classes of mobile terminals. When a network entity in one RAN is aware of loading conditions in another RAN, the occurrences of ping-ponging reselections may be decreased or eliminated.

In an aspect of the disclosure, the method comprises receiving information related to the operational status of a first network at a second network, and determining at the second network whether to direct an idle user equipment (UE) in the second network to reselect the first network based on the operational status of the first network. The first and second networks may employ different radio access technologies (RATs).

In an aspect of the disclosure, the information related to the operational status of the first network indicates a loading factor of the first network. The information related to the operational status of the first network may identify one or more UEs permitted to access the first network. The information related to the operational status of the first network may identify one or more UEs for whom access to the first network is forbidden. The information related to the operational status of the first network may define an idle reselection priority threshold which is used to determine whether one or more UEs are permitted to access the first network. The information related to the operational status of the first network may define an idle reselection priority threshold which is used to determine whether one or more UEs are forbidden to access the first network.

In an aspect of the disclosure, the information related to the operational status of the first network may describe a plurality of classes associated with one or more UEs, including a class of users allowed to access the first network and a class of users forbidden access to the first network. The information related to the operational status of the first network may define one or more classes permitted to access the first network. The information related to the operational status of the first network may define one or more classes forbidden access to the first network. The information related to the operational status of the first network may define a first percentage of available resources. One or more UEs may be permitted to access first network when available resources remaining in the first network exceed the first percentage. The information related to the operational status of the first network may define a second available resources percentage. One or more UEs may be forbidden access to the first network when available resources remaining in the first network are less than the second percentage. In an aspect of the disclosure, at least one of the different RATs employs enhanced high rate packet data (eHRPD) technology. In some embodiments, at least one of the different RATs is LTE.

In an aspect of the disclosure, the information related to the operational status of the first network may comprise a randomization redirection indicator. The information related to the operational status of the first network may comprise a randomization bitmap. The information related to the operational status of the first network may be received in an internetworking message. The internetworking message may be communicated between an evolved access network (eAN)/evolved packet control function (ePCF) and/or HRPD serving gateway (HSGW) entity and a mobility management entity (MME)/serving gateway (SGW) and/or packet data network (PDN)-gateway (PDN-GW).

In an aspect of the disclosure, the method comprises responding to the internetworking message by providing a response to the first network indicating operational status of the second network. The internetworking message may comprise a change notification request message. The response may be transmitted in a change notification response message to the first network.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating internetworking between different RATs.

FIG. 8 is a diagram illustrating messaging between networks employing different RATs.

FIG. 9 is a diagram illustrating messaging between networks employing different RATs.

FIG. 10 is a diagram illustrating messaging between networks employing different RATs.

FIG. 11 is a diagram illustrating messaging between networks employing different RATs.

FIG. 12 is a flow chart of a method of wireless communication.

FIG. 13 is a conceptual data flow diagram illustrating the data flow between different modules/means/components in an exemplary apparatus.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

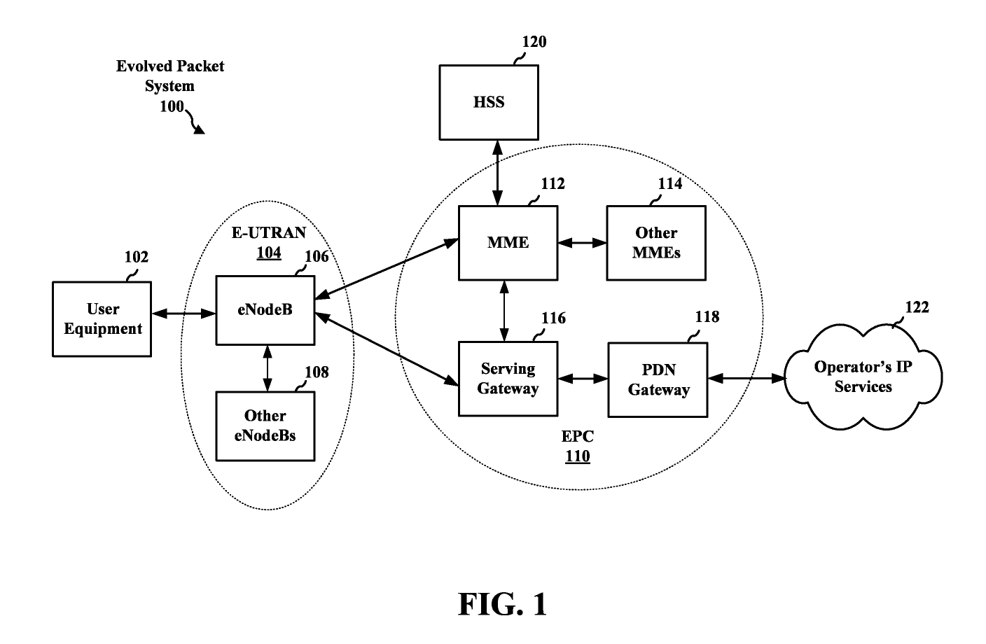

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108.

The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

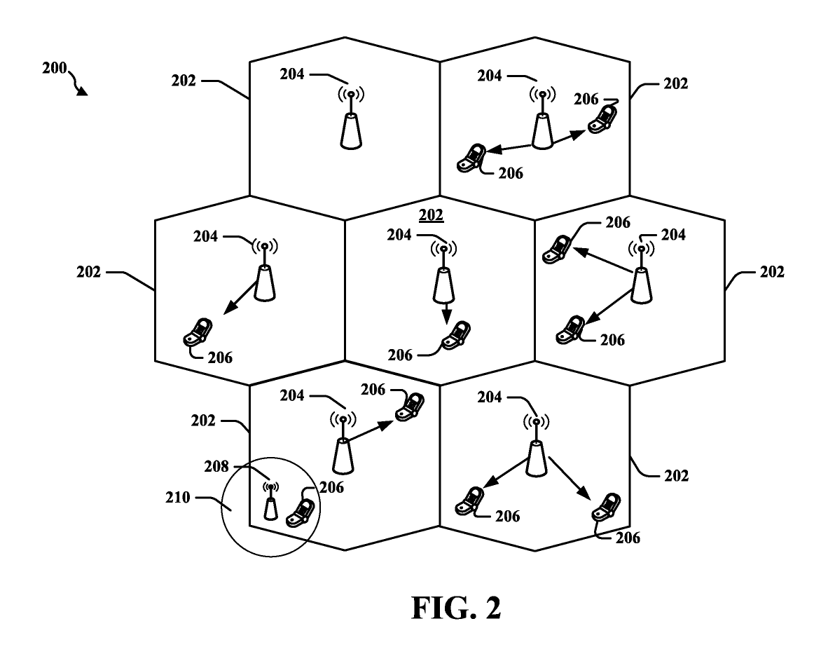

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

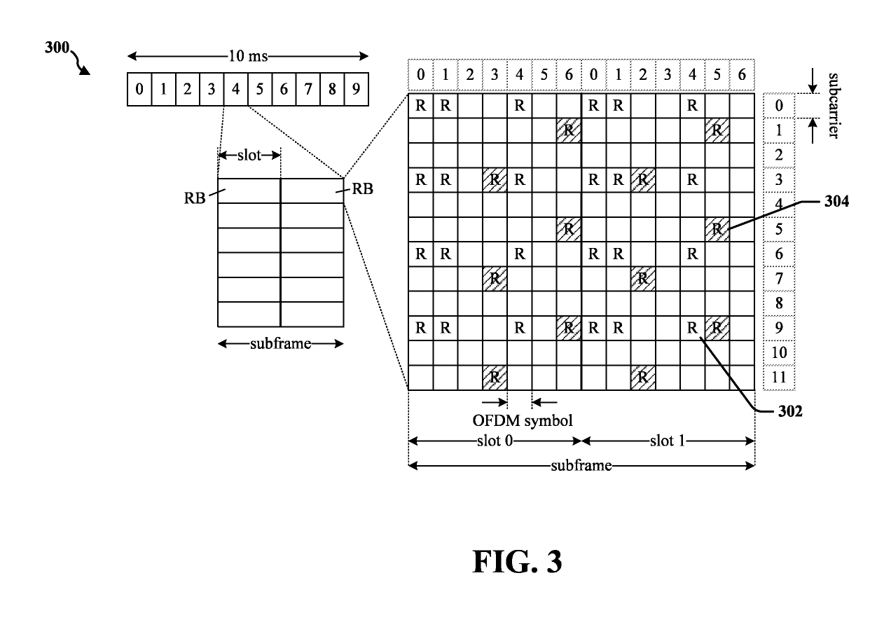

FIG. 3 is a diagram 300 illustrating an example of a DL frame structure in LTE.

A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

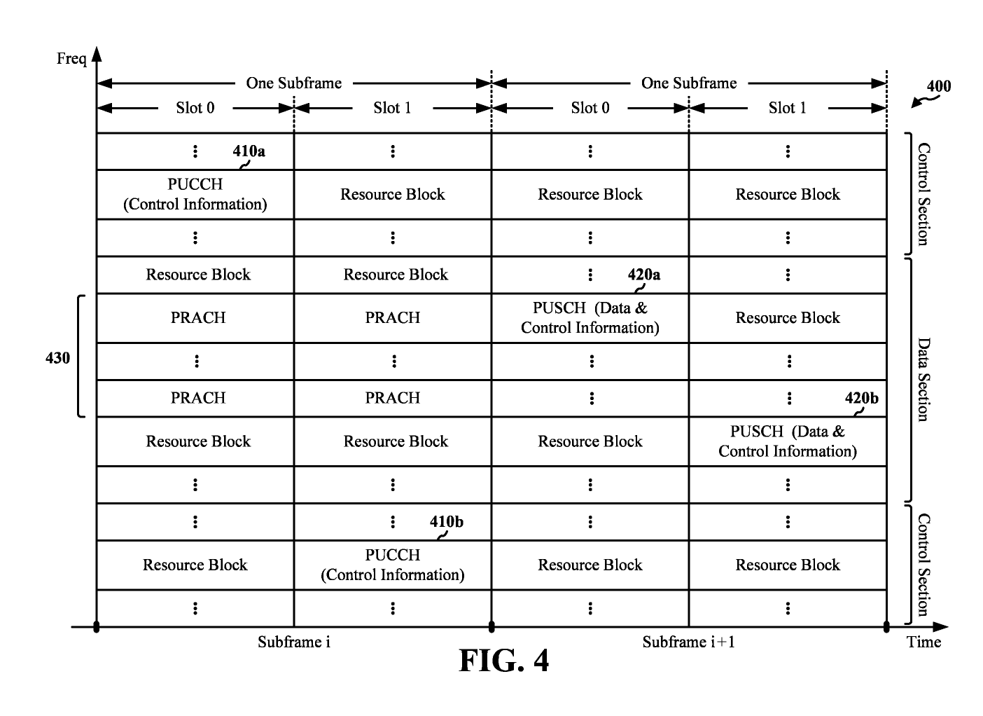

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

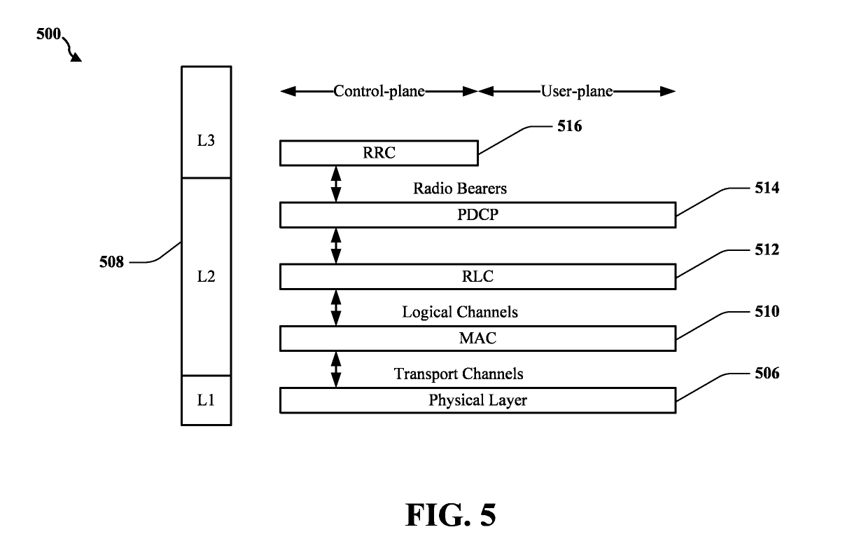

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

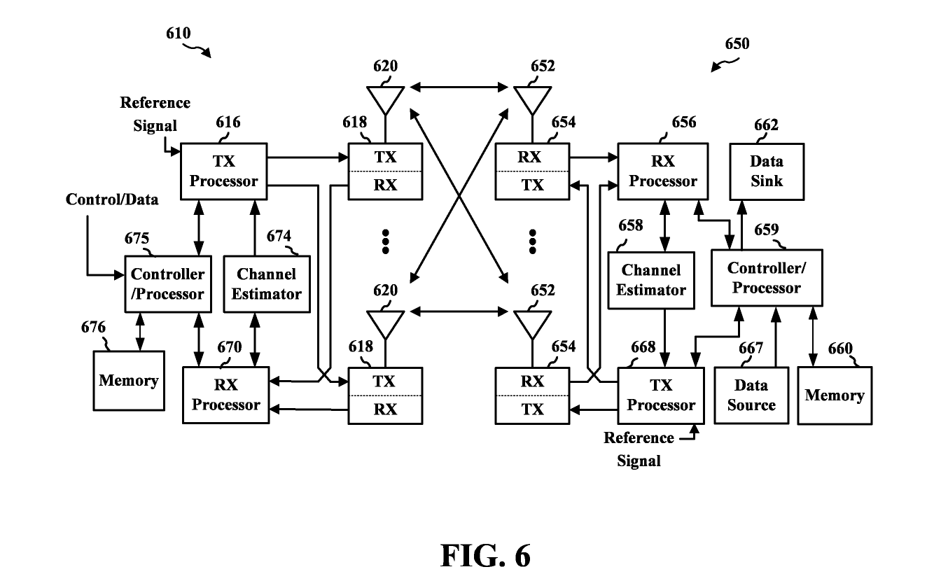

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

Certain embodiments provide systems and methods that employ inter-network communication to avoid ping-ponging caused by repeated inter-RAT idle reselection. Referring again to FIG. 2, UE 206 may be located within the coverage of multiple cells 202 and these cells 202 may use different frequencies and/or different RATs. When idle, UE 206 may select a frequency and a RAT to camp on based on a priority list. This priority list may identify sets of frequencies, RATs associated with each frequency, and a priority assigned to each frequency. For example, the priority list may include three frequencies X, Y and Z. Frequency X may be used for LTE and may have the highest priority, frequency Y may be used for GSM and may have the lowest priority, and frequency Z may be used for W-CDMA and may have medium priority. In general, the priority list may include any number of frequencies for any set of RATs and may be specific for the UE location. UE 206 may be configured to prefer LTE, when available, by defining the priority list with LTE frequencies at the highest priority and with frequencies for other RATs at lower priorities.

In idle mode, UE 206 may identify all frequencies and/or RATs on which it is able to find a suitable cell for normal LTE operation. UE 206 may camp on the RAT with the highest priority among all identified RATs and UE 206 may remain on this RAT until the RAT becomes unavailable, or until a higher priority RAT becomes available. The behavior of UE 206 in idle mode may conform or be consistent with operations specified by a standard or specification such as the publicly available 3GPP TS 36.304 publication: “Evolved Universal Terrestrial Radio Access (E-UTRA); User Equipment (UE) procedures in idle mode.”

In one example, UE 206 may be able to receive packet-switched (PS) data services from an LTE network and may camp on the LTE network while in the idle mode. If the LTE network does not adequately support voice-over-Internet protocol (VoIP), UE 206 may be transferred to another wireless network of another RAT to initiate or receive voice calls. This transfer may be referred to as circuit-switched (CS) fallback and may be accomplished by inter-RAT (IRAT) handover or redirection executed by UE 206. For example, UE 206 may reselect a RAT that supports voice service, such as 1xRTT, W-CDMA, GSM, or other RAT. UE 206 may transfer from an LTE network to another RAT if LTE service is lost, particularly when UE 206 physically moves through a coverage area of a communication system. The gap in service may be referred to as a network coverage hole, or in the specific example of LTE, an LTE hole.

Certain embodiments of the invention provide systems and methods that facilitate communication between RANs using different RATs to enable load balancing and to minimize reselections when one or more of the RANS are experiencing substantial or heavy loading.

The current RAN of UE 206 may direct UE 206 to reselect an available cell that operates using a different RAT, such as eHRPD or LTE, when loading of the current RAN increases and/or based on priorities set for UE 206. For example, one or more of the LTE and eHRPD RATs may be designated as a higher priority RAT for UE 206. When the UE 206 is camped on a lower priority network, the UE 206 may attempt to reselect the higher-priority network when it becomes available. Conventionally, while UE 206 is camped in the lower-priority RAT, UE 206 may be directed to switch between RATs according to reselection criteria regardless of relative loading between the different RATs.

Networks employing different RATs may not exchange complete information describing their respective operational states. In some circumstances, a first RAN may redirect a UE 206 to a second RAN based on certain criteria, while second network may redirect the same UE back to the first RAN without coordination between the RANs. Without knowing the reselection criteria of other networks or network technologies, RANs may have conflicting priorities or criteria that cause a ping-pong effect where UE 206 is constantly reselecting between the same RANs. Issues typically arise when UE 206 reselects between two different RANs that employ different RATs, and when each of the two RANs is not able to determine the operational status of the other RAN. For example, when UE 206 is idle and camped in a first, heavily-loaded RAN, UE 206 may be directed to reselect a second RAN operating using a different RAT. However, the second RAN may also be heavily loaded and may direct UE 206 to reselect the first RAN. In conventional systems, repeated reselections may ensue because information is not exchanged between source and target RATs. Repeated inter-RAT idle reselections can cause conflicts and issues between LTE and eHRPD systems, for example.

Certain embodiments of the invention provide systems and methods in which network entities exchange operational information through network interfaces, thereby reducing or eliminating ping-pong reselection. Information exchanged between source and target RATs through the network interfaces may include operational status, loading conditions, loading thresholds, priorities, and other information. A source network can indicate its information to a target network to assist load balancing between the networks. Information can be provided in a one-way communication from the source network to the target network, and/or information can be exchanged bi-directionally between the networks, whereby both networks provide loading information. In some embodiments, a source network may provide its operational information to a plurality of target networks.

In some embodiments, operational information comprises load-related information that may include a simple indicator that indicates that the source network is either loaded or not-loaded. In one example, the simple indicator may indicate that a loading threshold has been exceeded such that reselections of the loaded network should be limited and/or prevented. In another example, an indicator may indicate that the source network can accept reselecting UEs 206. A combination of thresholds may be used such that the indicator has multiple levels.

In some embodiments, multiple thresholds may be configured to accommodate different classes of UEs 206 and/or operational differences between UEs 206. In one example, one or more UEs 206 may be prohibited from reselecting a RAT when loading exceeds a first threshold, while other UEs 206 may be permitted to reselect the RAT unless loading exceeds a second threshold.

In some embodiments the load-related information specifies remaining resources in a source network. The remaining resources may be quantified as a percentage of total resources available in the source network and/or the load-related information may specify a percentage or number of UEs 206 that can be supported by the source network. For example, the remaining number of UEs 206 that can be accepted by the source network may be quantified as a percentage of the total UEs 206 that can be supported by the source network or as a current occupation percentage of the source network.

In some embodiments, load-related information may identify UEs 206 that are permitted to access the source network and/or UEs 206 that are forbidden access to the source network. Classes of UEs may be defined, whereby some classes may be allowed access to the source network, while others may be denied access to the source network under the same operational conditions.

In some embodiments, load-related information may specify how priorities and permissions to access the source network are to be assigned among UEs 206 and/or classes of UEs 206. For example, a first percentage of capacity and/or network resources may be allocated to Class A, while a second percentage of capacity and/or network resources may be allocated to Class B, etc. In the latter example, Class A UEs 206 or users may be accepted until the allocated resources or occupancy level of Class has been reached.

In some embodiments, a priority may be assigned to classes or individual UEs, and the priority may change based on the occupancy level or resource usage of the source network. Reselection may be conditioned on priorities defined in the load-related information for a UE 206 or class of UEs 206. For example, a decision to perform reselection may be based on the relationship between assigned priorities and a reselection priority threshold, whereby a UE 206 may reselect a source network if a priority assigned to the UE 206 equals or exceeds a current reselection priority threshold. The load-related information may also comprise a randomization redirection indicator and an associated recommended randomization bitmap.

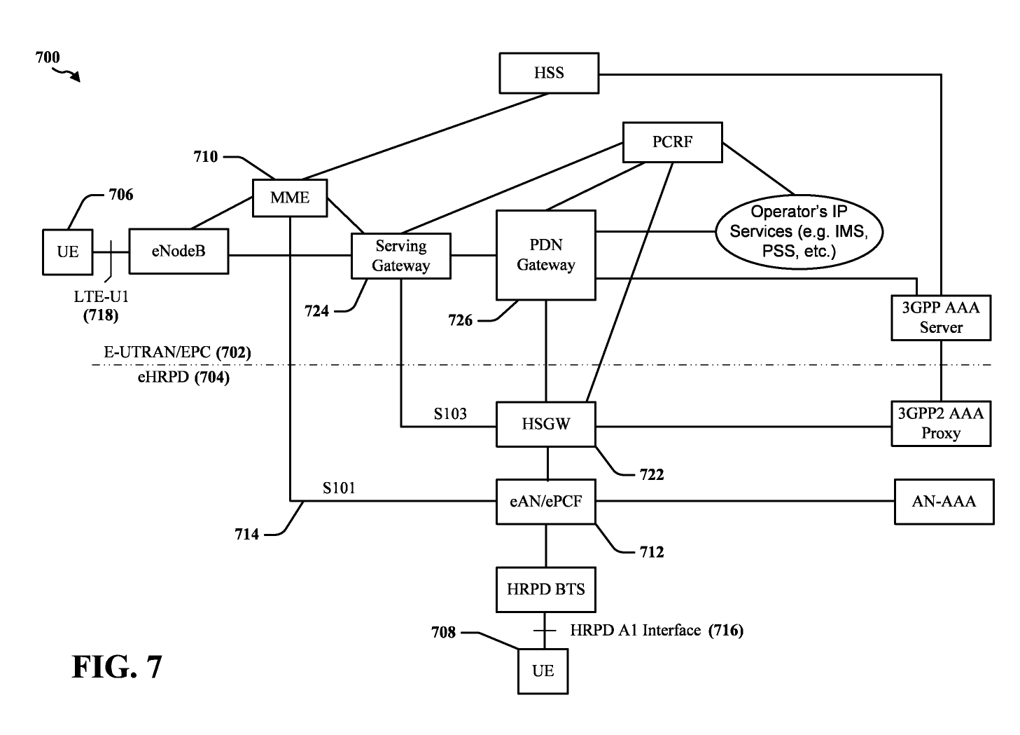

FIG. 7 illustrates an internetworking environment in which UEs 706 and 708 are connected to E-UTRAN 702 and eHRPD 704 RAN, respectively. In certain embodiments, a source RAN 702 or 704 may transmit operational status that comprises load-related information identifying information such as available resources, occupancy levels, priorities and other information to target RAN 704 or 702. Target RAN 704 or 702 may acknowledge the information sent by the source RAN 702 or 704 and may send additional information indicating status and/or changes in status of the target RAN 704 or 702 responsive to the operational status sent by source RAN 702 or 704. The target RAN 704 or 702 may provide its operational status in a response message sent to the source RAN 702 or 704. The information communicated between source and target RANS 702 and 704 may be carried in one or more message exchanges. For example, internetworking messages may be adapted to provide a request and response framework for communicating operational status. Internetworking messages may be adapted by reusing or extending message types or content used for other purposes.

In one example, interworking messages communicated over an 5101 connection 714 may be adapted to carry operational status between network entities 710 and 712 used in different RATs. The 5101 connection 714 may provide a signaling interface between an MME 710 and an eAN/ePCF 712, which allows a UE 706 or 708 to tunnel air interface signaling between systems 702 and 704. UEs 706 and 708 may exchange handover messages before handover occurs, thereby improving handover between the two systems 702 and 704. For example, UE 706 may provide signaling and other information related to an HRPD air interface 716 through LTE 718 to permit pre-registration during mobility operations.

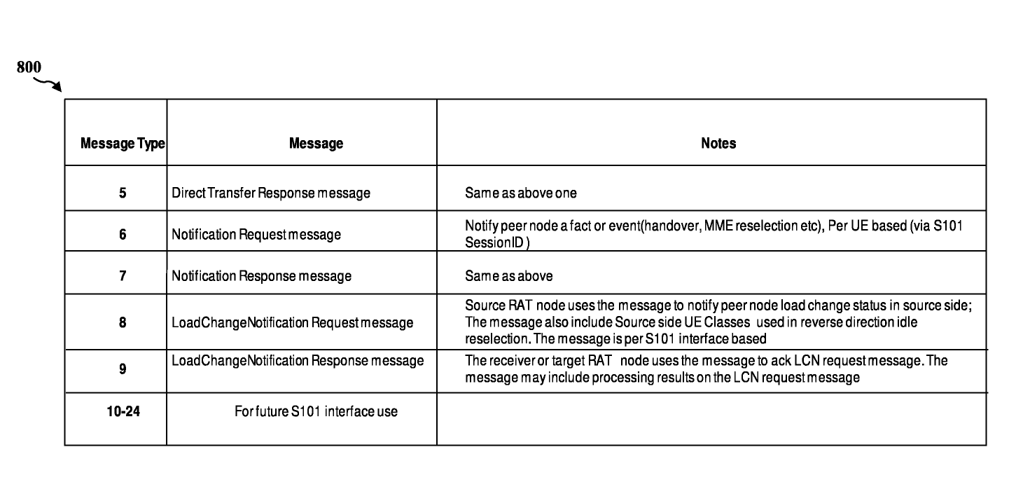

In some embodiments, eHRPD/LTE interworking may be improved by extending the S101 interface 714, and/or by defining new S101 messages. With reference to FIG. 8, the messages may be based on, or be variants of, notification messages 800. In the example depicted in FIG. 8, a network may indicate its current operational status through a “load change notification” (LCN) request message in which a source RAT node 710 or 712 notifies one or more peer nodes of changes in load status in the source network. The request message can also include a listing of source-side UE classes which may be used in reverse direction idle reselection. The one or more peer nodes 710 or 712 may respond using a LCN response message in which a receiver or target RAT node may acknowledge the LCN request message in an LCN response message. The LCN response message may include results of processing the information in the LCN request message. A source RAT may indicate its operational status information to the neighbors of a target RAT cell, and the target RAT cell may respond with processing results.

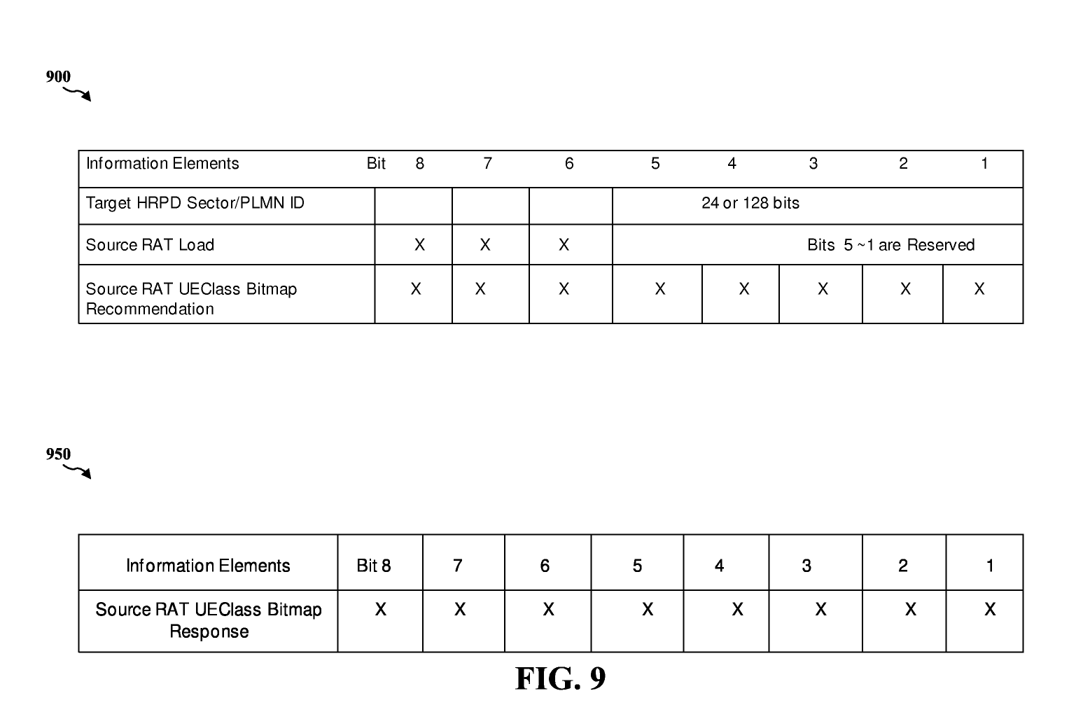

FIG. 9 includes an example 900 of a LCN request message sent by a source RAT node. The source RAT node may include in the “Target HRPD sector/PLMN”information element (IE) of message 900 an indication of which target HRPD sector/PLMN the source RAT is reporting overall neighbors' load status. The “Source RAT Load” IE may have various formats. In one format, the source RAT node may define overall remaining available load resources for the neighbors of the target HRPD sector/PLMN ID. For example, a value may be set that ranges between 0% and 100%, in units of 1/8. In another format, the source RAT may define a priority threshold, whereby UEs 706 or 708 with priorities higher than the threshold are permitted to reselect source RAT system. The load threshold that triggers the source RAT to send the information element may be configured according to implementation.

The “Source RAT UEClass Bitmap Recommendation” IE may be used by the source RAT to specify which UE classes in the target HRPD Sector/PLMN ID are allowed to reselect the source RAT system during reverse direction idle reselection.

This information element may also include a radomization bitmap. The source side may set the Nth (1˜8) bit to 1 if UE class N users in target HRPD Sector/PLMN ID are allowed to reselect source RAT system during reverse idle reselection. The information element may set the Nth bit to 0. In randomization bitmap, ‘1’ may mean that the UE class in that randomization group was selected.

FIG. 9 also includes an example of a LCN response message 950. Here, the “Source RAT UEClass Bitmap Response” IE may optionally be provided and may have a plurality of formats. In one format, the target RAT node may use the IE to indicate processing results of the source RAT bitmap recommendation. The target RAT node may set the Nth (1˜8) bit to 1 if UE Class N users in the target RAT side have been directed to reselect source RAT system in reverse direction idle reselection. Otherwise, target RAT node may set the Nth bit to 0. In another format, the target RAT may use the information element to carry a PriorityThreshold target RAT as recommended by the source RAT. In the target RAT system, UEs 706 or 708 with priorities higher than the threshold may be permitted to reselect the source RAT system.

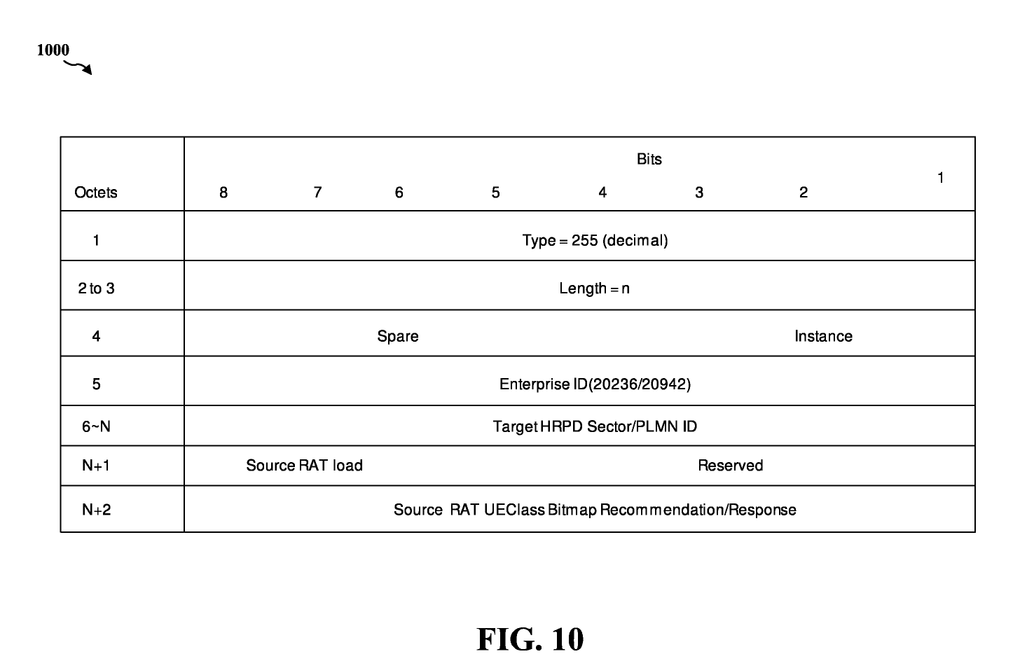

FIG. 10 depicts another example of adaptation of an S101 message 1000. Here, the S101 interface may be extended and certain common S101 message IEs may be reused. Adaptation can be applied per UE 706 or 708, or per S101 interface (for path messages). A private extension IE may be introduced in every S101 message to support certain aspects of the invention disclosed herein. For example, each vendor and/or operator may be assigned private numbers that can be used to indicate the format and meaning of contents of the private extension elements. As illustrated, numbers 20236 and 20942 are used for private extension.

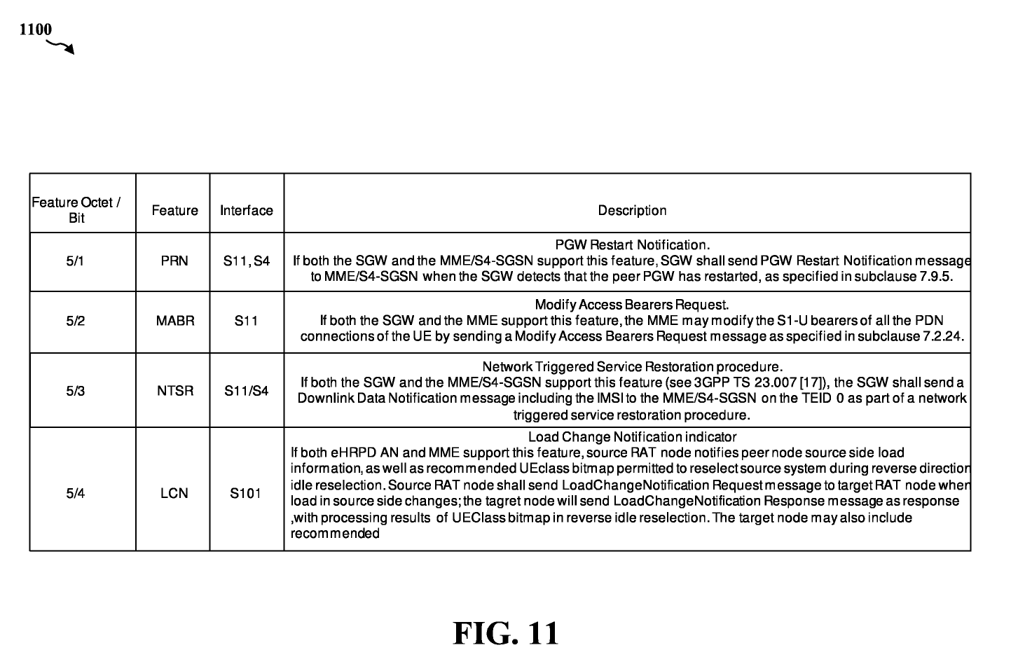

FIG. 11 depicts another example of adaptation of an S101 message 1100 by extending the S101 interface and S101 path message. Adaptation may be made per S101 interface. LCN messaging may be incorporated as a node feature. For example, MME 710 and/or an entity of eHRPD 704 may declare support for the LCN messaging feature in path messages such as Echo Request/Response. When loading in a source RAT changes, the source RAT node may send an LCN request message. The target RAT may respond with LCN Response messages.

In some embodiments, a source RAT reports neighbors load information only for one sector/PLMN each time. However, some embodiments use extended messages to convey neighbors' load information for multiple target sectors in a single message. In some embodiments, the source RAT can piggyback processing results for the information sent previously from the target RAT on information sent to target RATs

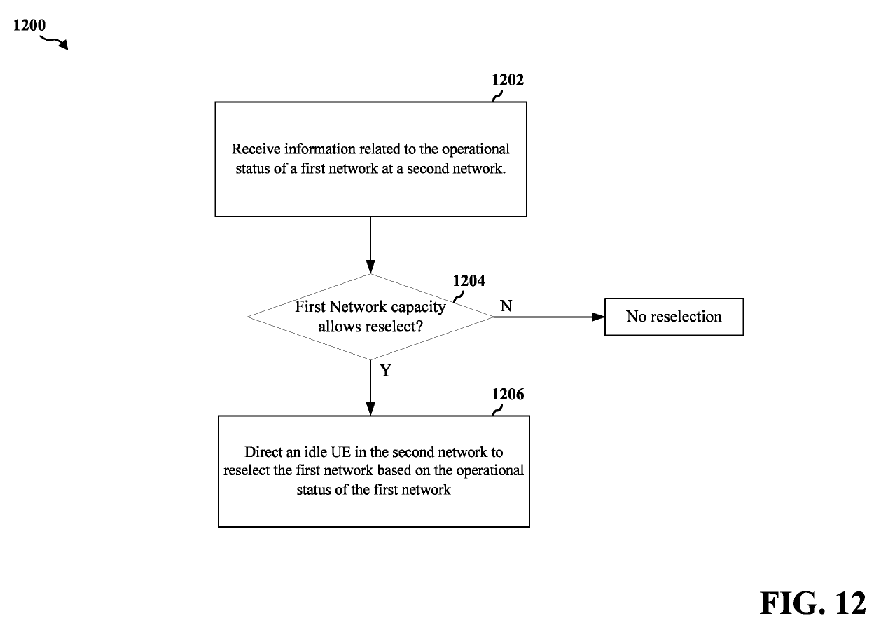

FIG. 12 is a flow chart 1200 of a method of wireless communication. The method may be performed by a network entity 710 or 712. At step 1202, a network entity 710 or 712 receives information related to the operational status of a first network at a second network. The first and second networks may employ different RATs. The information related to the operational status of the first network may indicate a loading factor of the first network. The information related to the operational status of the first network may identify one or more UEs 706 and 708 permitted to access the first network. The information related to the operational status of the first network may identify one or more UEs 706 and 708 which are forbidden access to the first network.

In some embodiments, the information related to the operational status of the first network may define an idle reselection priority threshold which is used to determine whether one or more UEs 706 and 708 are permitted to access the first network. The information related to the operational status of the first network may define an idle reselection priority threshold which is used to determine whether one or more UEs 706 and 708 are forbidden access to the first network.

In some embodiments, the information related to the operational status of the first network may describe a plurality of classes associated with one or more UEs 706 and 708, including a class of users of UEs 706 and 708 allowed to access the first network and a class of users forbidden access to the first network. The information related to the operational status of the first network may define one or more classes of UEs 706 and 708 permitted to access the first network. The information related to the operational status of the first network may define one or more classes of UEs 706 and 708 forbidden access to the first network. The information related to the operational status of the first network may define a first percentage of available resources. One or more UEs 706 and 708 may be permitted to access first network when available resources remaining in the first network exceed the first percentage. The information related to the operational status of the first network may define a second available resources percentage. One or more UEs 706 and 708 may be forbidden access to the first network when available resources remaining in the first network are less than the second percentage.

In some embodiments, the information related to the operational status of the first network may comprise a randomization redirection indicator. The information related to the operational status of the first network may comprise a randomization bitmap.

In some embodiments, the information related to the operational status of the first network is received in an internetworking message. The internetworking message may be communicated between an eAN/ePCF 712 or HSGW 722 and a MME 710, serving gateway (SGW) 724 or PDN gateway 726.

The method may comprise responding to the internetworking message by providing a response to the first network indicating operational status of the second network. The internetworking message may comprise a change notification request message. The response may include a change notification response message to the first network.

At step 1204, network entity 710 or 712 may determine whether to direct at step 1206, an idle UEs 706 or 708 in the second network to reselect the first network. The determination may be based on the operational status of the first network.

If the operational status of the first network does not have sufficient capacity, of for another reason prefers that no reselection take place, then, the process terminates at step 1208 with no reselection being directed.

In some embodiments, at least one of the different RATs is eHRPD. In some embodiments, at least one of the different RATs is LTE.

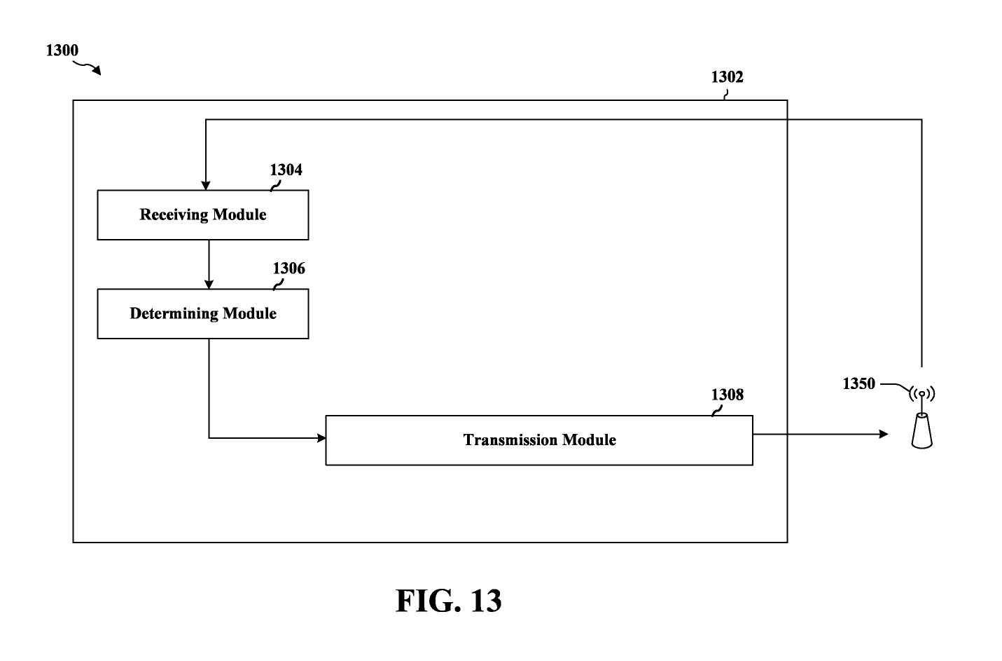

FIG. 13 is a conceptual data flow diagram 1300 illustrating the data flow between different modules/means/components in an exemplary apparatus 1302. The apparatus may be a network entity 710 or 712, for example. The apparatus includes a module 1304 that receives loading-related information and operational status from another network entity 712 or 710, a module 1306 that determines whether a UE 706 or 708 can perform a reselection, and a module 1308 that directs or otherwise causes the UE to perform a reselection.

The apparatus may include additional modules that perform each of the steps of the algorithm in the aforementioned flow chart of FIG. 12. As such, each step in the aforementioned flow chart of FIG. 12 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

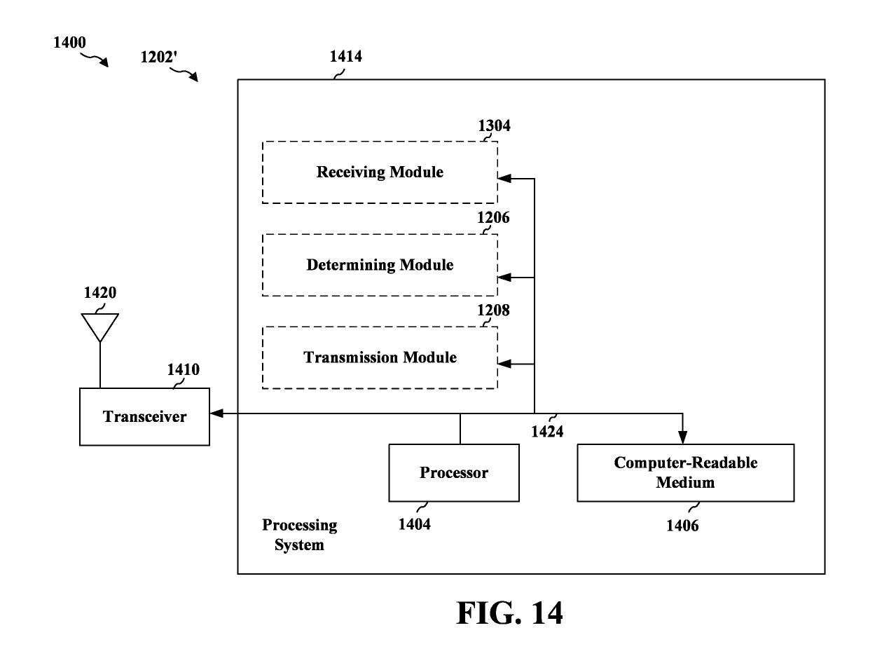

FIG. 14 is a diagram 1400 illustrating an example of a hardware implementation for an apparatus 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1304, 1306, 1308, and the computer-readable medium 1406. The bus 1424 may also link various other circuits such as timing sources, peripherals, voltage regulators, and power management circuits, which are well known in the art, and therefore, will not be described any further.

In some embodiments, the processing system 1414 may be coupled to a transceiver 1410, or to a network entity 710 or 712 that communicates with a UE 706 or 708 using transceiver 1410. The transceiver 1410 is coupled to one or more antennas 1420. The transceiver 1410 provides a means for communicating with various other apparatus over a transmission medium. The processing system 1414 includes a processor 1404 coupled to a computer-readable medium 1406. The processor 1404 is responsible for general processing, including the execution of software stored on the computer-readable medium 1406. The software, when executed by the processor 1404, causes the processing system 1414 to perform the various functions described supra for any particular apparatus. The computer-readable medium 1406 may also be used for storing data that is manipulated by the processor 1404 when executing software. The processing system further includes at least one of the modules 1304, 1306, and 1308. The modules may be software modules running in the processor 1404, resident/stored in the computer readable medium 1406, one or more hardware modules coupled to the processor 1404, or some combination thereof. The processing system 1414 may be a component of the eNB 610 and may include the memory 676 and/or at least one of the TX processor 616, the RX processor 670, and the controller/processor 675.

In one configuration, the apparatus 1302/1302′ for wireless communication includes means 1304 for receiving information related to the operational status of a first network at a second network, means 1306 for determining at the second network whether to direct an idle UE in the second network to reselect the first network based on the operational status of the first network, and transmission means 1308 for responding to the received information and/or for directing UE 706 or 708 to perform a reselection.

The aforementioned means may be one or more of the aforementioned modules of the apparatus 1302 and/or the processing system 1414 of the apparatus 1302′ configured to perform the functions recited by the aforementioned means. As described supra, the processing system 1414 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving information related to operational status of a first network at a second network, wherein the first and second networks employ different radio access technologies (RATS); and
determining at the second network whether to direct an idle user equipment (UE) in the second network to reselect the first network based on the operational status of the first network.

2. The method of claim 1, wherein the information related to the operational status of the first network indicates a loading factor of the first network.

3. The method of claim 1, wherein the information related to the operational status of the first network identifies one or more UEs permitted to access the first network.

4. The method of claim 3, wherein the information related to the operational status of the first network identifies one or more UEs for which access to the first network is forbidden.

5. The method of claim 1, wherein the information related to the operational status of the first network defines an idle reselection priority threshold which is used to determine whether one or more UEs are permitted to access the first network.

6. The method of claim 5, wherein the information related to the operational status of the first network defines an idle reselection priority threshold which is used to determine whether one or more UEs are forbidden to access the first network.

7. The method of claim 1, wherein the information related to the operational status of the first network describes a plurality of classes associated with one or more UEs, including a class of users allowed to access the first network and a class of users forbidden access to the first network.

8. The method of claim 7, wherein the information related to the operational status of the first network defines one or more classes permitted to access the first network.

9. The method of claim 7, wherein the information related to the operational status of the first network defines one or more classes forbidden access to the first network.

10. The method of claim 1, wherein the information related to the operational status of the first network defines a first percentage of available resources, wherein one or more UEs are permitted to access first network when available resources remaining in the first network exceed the first percentage.

11. The method of claim 10, wherein the information related to the operational status of the first network defines a second available resources percentage, wherein one or more UEs are forbidden access to the first network when available resources remaining in the first network are less than the second percentage.

12. The method of claim 1, wherein the information related to the operational status of the first network comprises a randomization redirection indicator.

13. The method of claim 12, wherein the information related to the operational status of the first network comprises a randomization bitmap.

14. The method of claim 1, wherein receiving the information related to the operational status of the first network includes receiving the information in an internetworking message.

15. The method of claim 14, wherein the internetworking message is communicated between one or more of an evolved access network, evolved packet control function and an enhanced high rate packet data (eHRPD) serving gateway and one or more of a mobility management entity, a serving gateway and a packet data network.

16. The method of claim 14, further comprising responding to the internetworking message by providing a response to the first network indicating operational status of the second network.

17. The method of claim 14, wherein the internetworking message comprises a change notification request message, and wherein providing the response comprises transmitting a change notification response message to the first network.

18. The method of claim 1, wherein at least one of the different RATs is eHRPD.

19. The method of claim 1, wherein at least one of the different RATs is a long term evolution technology.

20. An apparatus for wireless communication, comprising:
means for receiving information related to operational status of a first network at a second network, wherein the first and second networks employ different radio access technologies (RATs); and
means for determining at the second network whether to direct an idle user equipment (UE) in the second network to reselect the first network based on the operational status of the first network.

21. The apparatus of claim 20, wherein the information related to the operational status of the first network indicates a loading factor of the first network.

22. The apparatus of claim 20, wherein the information related to the operational status of the first network identifies one or more UEs permitted to access the first network.

23. The apparatus of claim 22, wherein the information related to the operational status of the first network identifies one or more UEs for which access to the first network is forbidden.

24. The apparatus of claim 20, wherein the information related to the operational status of the first network defines an idle reselection priority threshold which is used to determine whether one or more UEs are permitted to access the first network.

25. The apparatus of claim 24, wherein the information related to the operational status of the first network defines an idle reselection priority threshold which is used to determine whether one or more UEs are forbidden to access the first network.

26. The apparatus of claim 20, wherein the information related to the operational status of the first network describes a plurality of classes associated with one or more UEs, including a class of users allowed to access the first network and a class of users forbidden access to the first network.

27. The apparatus of claim 26, wherein the information related to the operational status of the first network defines one or more classes permitted to access the first network.

28. The apparatus of claim 26, wherein the information related to the operational status of the first network defines one or more classes forbidden access to the first network.

29. The apparatus of claim 20, wherein the information related to the operational status of the first network defines a first percentage of available resources, wherein one or more UEs are permitted to access first network when available resources remaining in the first network exceed the first percentage.

30. The apparatus of claim 29, wherein the information related to the operational status of the first network defines a second available resources percentage, wherein one or more UEs are forbidden access to the first network when available resources remaining in the first network are less than the second percentage.

31. The apparatus of claim 20, wherein the information related to the operational status of the first network comprises a randomization redirection indicator.

32. The apparatus of claim 31, wherein the information related to the operational status of the first network comprises a randomization bitmap.

33. The apparatus of claim 20, wherein the means for receiving the information related to the operational status of the first network receives the information in an internetworking message.

34. The apparatus of claim 33, wherein the internetworking message is communicated between one or more of an evolved access network, evolved packet control function and an enhanced high rate packet data (eHRPD) serving gateway and one or more of a mobility management entity, a serving gateway and a packet data network.

35. The apparatus of claim 33, further comprising means for responding to the internetworking message, wherein the means for responding provides a response to the first network indicating operational status of the second network.

36. The apparatus of claim 33, wherein the internetworking message comprises a change notification request message, and wherein the means for responding transmits a change notification response message to the first network.

37. The apparatus of claim 20, wherein at least one of the different RATs is eHRPD.

38. The apparatus of claim 20, wherein at least one of the different RATs is a long term evolution technology.

39. An apparatus for wireless communication, comprising:
a processing system configured to:
receive information related to operational status of a first network at a second network, wherein the first and second networks employ different radio access technologies (RATs); and
determine at the second network whether to direct an idle user equipment (UE) in the second network to reselect the first network based on the operational status of the first network.

40. The apparatus of claim 39, wherein the information related to the operational status of the first network identifies one or more UEs permitted to access the first network or one or more UEs for which access to the first network is forbidden.

41. The apparatus of claim 39, wherein the information related to the operational status of the first network defines an idle reselection priority threshold which is used to determine whether one or more UEs are permitted to access the first network or whether one or more UEs are forbidden to access the first network.

42. The apparatus of claim 39, wherein the information related to the operational status of the first network describes a plurality of classes associated with one or more UEs, including a class of users allowed to access the first network and a class of users forbidden access to the first network.

43. The apparatus of claim 42, wherein the information related to the operational status of the first network defines one or more classes permitted to access the first network or one or more classes forbidden access to the first network.

44. The apparatus of claim 39, wherein the information related to the operational status of the first network defines a percentage of available resources, wherein one or more UEs are permitted to access first network when available resources remaining in the first network exceed the percentage, or one or more UEs are forbidden access to the first network when available resources remaining in the first network are less than the percentage.

45. The apparatus of claim 39, wherein the information related to the operational status of the first network comprises a randomization redirection indicator.

46. The apparatus of claim 45, wherein the information related to the operational status of the first network comprises a randomization bitmap.

47. The apparatus of claim 39, wherein the processing system receives the information related to the operational status of the first network in an internetworking message.

48. The apparatus of claim 47, wherein the internetworking message is communicated between one or more of an evolved access network, evolved packet control function and an enhanced high rate packet data (eHRPD) serving gateway and one or more of a mobility management entity, a serving gateway and a packet data network.

49. The apparatus of claim 47, wherein the processing system is configured to respond to the internetworking message by providing a response to the first network indicating operational status of the second network.

50. The apparatus of claim 47, wherein the internetworking message comprises a change notification request message, and wherein providing the response comprises transmitting a change notification response message to the first network.

51. A computer program product, comprising:
a computer-readable medium comprising code for:
receiving information related to operational status of a first network at a second network, wherein the first and second networks employ different radio access technologies (RATs); and
determining at the second network whether to direct an idle user equipment (UE) in the second network to reselect the first network based on the operational status of the first network.

52. The computer program product of claim 51, wherein the information related to the operational status of the first network identifies one or more UEs permitted to access the first network or one or more UEs for which access to the first network is forbidden.

53. The computer program product of claim 51, wherein the information related to the operational status of the first network defines an idle reselection priority threshold which is used to determine whether one or more UEs are permitted to access the first network or whether one or more UEs are forbidden to access the first network.

54. The computer program product of claim 51, wherein the information related to the operational status of the first network describes a plurality of classes associated with one or more UEs, including a class of users allowed to access the first network and a class of users forbidden access to the first network.

55. The computer program product of claim 54, wherein the information related to the operational status of the first network defines one or more classes permitted to access the first network or one or more classes forbidden access to the first network.

56. The computer program product of claim 51, wherein the information related to the operational status of the first network defines a percentage of available resources, wherein one or more UEs are permitted to access first network when available resources remaining in the first network exceed the percentage, or one or more UEs are forbidden access to the first network when available resources remaining in the first network are less than the percentage.

57. The computer program product of claim 51, wherein the information related to the operational status of the first network comprises a randomization redirection indicator.

58. The computer program product of claim 57, wherein the information related to the operational status of the first network comprises a randomization bitmap.

59. The computer program product of claim 51, wherein receiving the information related to the operational status of the first network includes receiving the information in an internetworking message.

60. The computer program product of claim 59, wherein the internetworking message is communicated between one or more of an evolved access network, evolved packet control function and an enhanced high rate packet data (eHRPD) serving gateway and one or more of a mobility management entity, a serving gateway and a packet data network.

61. The computer program product of claim 59, wherein the computer-readable medium comprises code for responding to the internetworking message by providing a response to the first network indicating operational status of the second network.

62. The computer program product of claim 59, wherein the internetworking message comprises a change notification request message, and wherein providing the response comprises transmitting a change notification response message to the first network.
